(19) United States
(12) Patent Application Publication
(10) Pub. No.: US 2005/0138102 A1
(43) Pub. Date: Jun. 23, 2005

(54) Arithmetic unit

(75) Inventor: Niichi Itoh, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/989,413

(22) Filed: Nov. 17, 2004

(30) Foreign Application Priority Data
Dec. 17, 2003 (JP) 2003-419038

(51) Int. Cl. G06F 7/52

(52) U.S. Cl. 708/620

(57) ABSTRACT

An arithmetic unit is provided which is capable of enhancing area efficiency while suppressing operating speed reduction. A third partial product adder (T101) is divided into a high order part (T101a) including high-order 12 bits and a low order part (T101b) including low-order 33 bits. The high order part (T101a) and the low order part (T101b) are placed in different rows in a Wallace tree array. Particularly, the low order part (T101b) is placed in a middle row in the Wallace tree array. More specifically, the low order part (T101b) is placed right under a high order part (S101a) and right above a low order part (S102b). The high order part (T101a) is placed in the bottom row of the Wallace tree array. More specifically, the high order part (T101a) is placed right under a high order part (S102a).

### BACKGROUND OF THE INVENTION

1. Field of the Invention

The present invention relates to an arithmetic unit using a Wallace tree array, and particularly to a multiplication device.

2. Description of the Background Art

Multiplication is one of the arithmetic operations that are most often performed in semiconductor integrated circuits, such as microcomputers, so that constructing high-speed computing systems necessarily requires implementing high-speed multiplication devices. The Booth's algorithm, which modifies the multiplier to reduce the total number of partial products, is a well-known method of realizing high-speed multiplication. Also well-known are multiplication devices using the Wallace tree, which adds partial products in a tree-like manner to sequentially reduce the total number of partial products. Multiplication devices adopting these two methods are disclosed for example in Japanese Patent Application Laid-Open Nos. 3-177922 (1991), 9-231056 (1997), and 2001-195235 (hereinafter these references are referred to as first to third patent documents, respectively).

However, in the multiplication device disclosed in the first patent document, the maximum-degree partial product adder (hereinafter referred to as “an mth partial product adder) in the Wallace tree largely protrudes in space beyond lower-degree partial product adders and shifter/inverters. The protrusion of the mth partial product adder forms dead (or unutilized) area in the Wallace tree array, thus lowering area efficiency.

In the multiplication device disclosed in the second patent document, partial product adders of respective degrees are each divided into a high order part and a low order part at a border between particular positions of the multiplicand, where the high and low order parts are placed in different rows in the Wallace tree array to prevent formation of dead area. Therefore the area can be used efficiently. However, because the low order part of the mth partial product adder is placed in the top row of the Wallace tree array while the high order part of the mth partial product adder is placed in the bottom row of the Wallace tree array, the carry path from the low order part of the mth partial product adder to its high order part (the carry path forms part of the critical path) requires a long interconnection, which lowers the multiplying speed.

Also, in the multiplication device disclosed in the third patent document, an undivided mth partial product adder is placed in a middle row in the Wallace tree array. Accordingly, unlike in the multiplication device disclosed by the second patent document, the mth partial product adder does not need a long carry path interconnection, allowing high multiplying speed. However, because of the same reason mentioned about the multiplication device of the first patent document, the mth partial product adder protrudes to cause dead area, lowering area efficiency.

Thus, conventional multiplication devices have a problem that enhancing area efficiency lowers multiplying speed, while increasing multiplying speed lowers area efficiency.

### SUMMARY OF THE INVENTION

An object of the present invention is to provide an arithmetic unit capable of enhancing area efficiency while suppressing reduction of operating speed.

An arithmetic unit according to the present invention includes a partial product generating portion, an array-form Wallace tree portion, and a final adder. The partial product generating portion receives a multiplicand and a multiplier and generates 0th partial products. The Wallace tree portion has jth partial product adders that add ith (0≦i≦m-1) partial products to generate jth (j=i+1) partial products, so as to perform an addition in a tree-like manner while sequentially reducing the number of partial products to finally output an mth partial product from an mth partial product adder. The final adder receives the mth partial product and obtains a result of multiplication of the multiplicand by the multiplier. The jth partial product adders are each divided into a plurality of parts at a border between particular positions of the multiplicand and the plurality of parts are placed in different rows in the array. The mth partial product adder includes a first part provided in a row at an end of the array and a second part provided in a middle row in the array.

It is possible to enhance area efficiency while suppressing reduction of operating speed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing the layout of a multiplication device according to a first preferred embodiment of the invention;

FIG. 2 is a circuit diagram showing part of the configuration of a first partial product adder;

FIGS. 3 and 4 together form a diagram schematically showing a first layout of a multiplication device according to a second preferred embodiment of the invention;

FIGS. 5 and 6 together form a diagram schematically showing a second layout of the multiplication device of the second preferred embodiment of the invention;

FIG. 7 is a diagram schematically showing the layout of a multiplication device according to a third preferred embodiment of the invention;

FIG. 8 is a diagram schematically showing the layout of a multiplication device according to a fourth preferred embodiment of the invention;

FIG. 9 is a diagram schematically showing the layout of a multiplication device according to a fifth preferred embodiment of the invention; and

FIG. 10 is a diagram schematically showing the layout of a multiplication device according to a sixth preferred embodiment of the invention.

### DESCRIPTION OF THE PREFERRED EMBODIMENTS

The arithmetic unit of the present invention is now described. While multiplication devices are explained below by way of example, the present invention is not limited to multiplication devices but is applicable to any arithmetic units using Wallace tree arrays, such as sum-of-products operation devices and division devices.

### First Preferred Embodiment

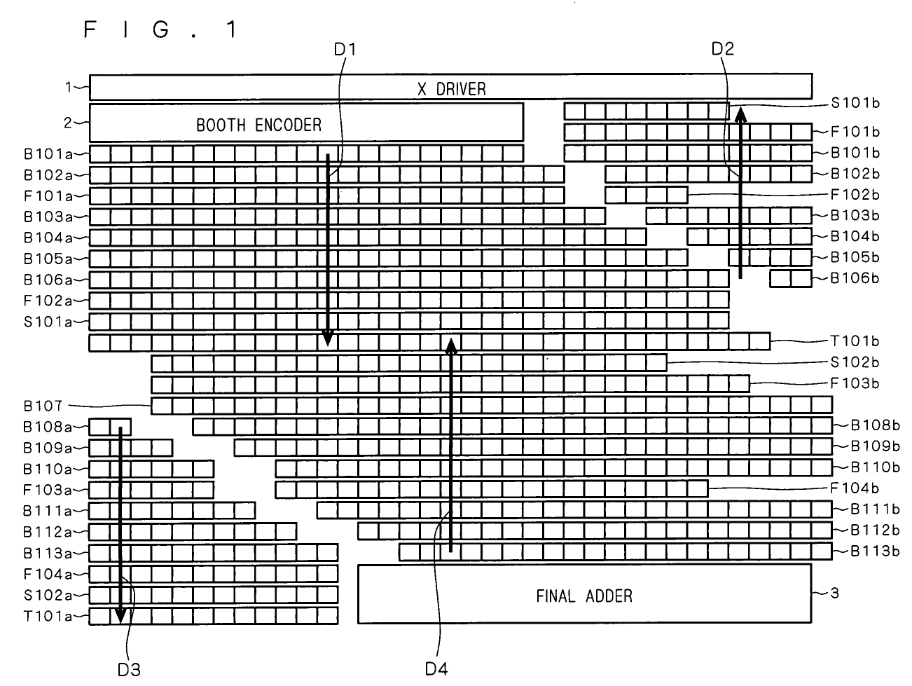

FIG. 1 is a diagram schematically showing the layout of a multiplication device of 32-bit multiplicand×25-bit multiplier, according to a first preferred embodiment of the invention (throughout this specification, “layout” means a layout that is configured as an integrated circuit on a semiconductor chip). The multiplication device includes a Wallace tree array, an X driver 1 provided at the top side of the Wallace tree array, a booth encoder 2 provided in the left part of the top side of the Wallace tree array, and a final adder 3 provided in the right part of the bottom side of the Wallace tree array.

A 25-bit multiplier is inputted to the booth encoder 2. The booth encoder 2 then reduces the multiplier according to a Booth's algorithm and outputs the reduced multiplier (hereinafter referred to as “a modified multiplier”). The multiplication device of the first preferred embodiment adopts a second-order Booth algorithm, so that the booth encoder 2 reduces the 25-bit multiplier to output a modified multiplier of 13 bits (booth1 to booth13).

The Wallace tree array includes booth selectors B101 to B113 (shown as B101a to B113a and B101b to B113b in FIG. 1), first partial product adders F101 to F104 (F101a to F104a and F101b to F104b in FIG. 1), second partial product adders S101 and S102 (S101a, S101b, S102a, and S102b in FIG. 1), and a third partial product adder T101 (T101a and T101b in FIG. 1).

The X driver 1, functioning as a driving buffer for driving the multiplicand, provides the multiplicand to the booth selectors B101 to B113.

The booth selectors B101 to B113 receive the modified multiplier from the booth encoder 2 and also receives the multiplicand from the X driver 1, and they generate and output 0th partial products. More specifically, the booth selectors B101 to B113 function as shifter/inverters; according to the second-order Booth algorithm, they generate 0th partial products by keeping the multiplicand unchanged when the modified multiplier is 1, 1-bit shifting the multiplicand when the modified multiplier is 2, and inverting the multiplicand when the modified multiplier is negative.

The booth selector B101 is divided into a high order part B101a including high-order 21 bits and a low order part B101b including low-order 12 bits, at the border between the 12th and 13th bits counted from its least significant bit, i.e. at the border between the 12th and 13th bits from the least significant bit of the multiplicand. The booth selector B101 receives the least significant bit “booth1” of the modified multiplier. The booth selector B102 is divided into a high order part B102a including high-order 23 bits and a low order part B102b including low-order 10 bits, at the border between the 10th and 11th bits counted from its least significant bit. The booth selector B102 receives the bit booth2 of the modified multiplier. The booth selector B103 is divided into a high order part B103a including high-order 25 bits and a low order part B103b including low-order 8 bits, at the border between the 8th and 9th bits counted from its least significant bit. The booth selector B103 receives the bit booth3 of the modified multiplier. The booth selector B104 is divided into a high order part B104a including high-order 27 bits and a low order part B104b including low-order 6 bits, at the border between the 6th and 7th bits counted from its least significant bit. The booth selector B104 receives the bit booth4 of the modified multiplier. The booth selector B105 is divided into a high order part B105a including high-order 29 bits and a low order part B105b including low-order 4 bits, at the border between the 4th and 5th bits counted from its least significant bit. The booth selector B105 receives the bit booth5 of the modified multiplier. The booth selector B106 is divided into a high order part B106a including high-order 31 bits and a low order part B106b including low-order 2 bits, at the border between the 2nd and 3rd bits counted from its least significant bit. The booth selector B106 receives the bit booth6 of the modified multiplier.

The booth selector B107 receives the bit booth7 of the modified multiplier. The booth selector B108 is divided into a high order part B108a including high-order 2 bits and a low order part B108b including low-order 31 bits, at the border between the 31st and 32nd bits counted from its least significant bit. The booth selector B108 receives the bit booth8 of the modified multiplier. The booth selector B109 is divided into a high order part B109a including high-order 4 bits and a low order part B109b including low-order 29 bits, at the border between the 29th and 30th bits counted from its least significant bit. The booth selector B109 receives the bit booth9 of the modified multiplier. The booth selector B110 is divided into a high order part B110a including high-order 6 bits and a low order part B110b including low-order 27 bits, at the border between the 27th and 28th bits counted from its least significant bit. The booth selector B110 receives the bit booth10 of the modified multiplier. The booth selector B111 is divided into a high order part B111a including high-order 8 bits and a low order part B111b including low-order 25 bits, at the border between the 25th and 26th bits counted from its least significant bit. The booth selector B111 receives the bit booth11 of the modified multiplier. The booth selector B112 is divided into a high order part B112a including high-order 10 bits and a low order part B112b including low-order 23 bits, at the border between the 23rd and 24th bits counted from its least significant bit. The booth selector B112 receives the bit booth12 of the modified multiplier. The booth selector B113 is divided into a high order part B113a including high-order 12 bits and a low order part B113b including low-order 21 bits, at the border between the 21st and 22nd bits counted from its least significant bit. The booth selector B113 receives the bit booth13 of the modified multiplier.

The first partial product adder F101 adds 0th partial products from the booth selectors B101 and B102 to generate and output a first partial product. The first partial product adder F101 is divided into a high order part F101a including high-order 23 bits and a low order part F101b including low-order 12 bits at the border between the 12th and 13th bits from its least significant bit. The high order part F101a and the low order part F101b are placed in different rows in the Wallace tree array. The first partial product adder F102 adds 0th partial products from the booth selectors B103 to B106 to generate and output a first partial product. The first partial product adder F102 is divided into a high order part F102a including high-order 31 bits and a low order part F102b including low-order 4 bits at the border between the 4th and 5th bits from its least significant bit. The high order part F102a and the low order part F102b are placed in different rows in the Wallace tree array. The first partial product adder F103 adds 0th partial products from the booth selectors B107 to B110 to generate and output a first partial product. The first partial product adder F103 is divided into a high order part F103a including high-order 6 bits and a low order part F103b including low-order 29 bits at the border between the 29th and 30th bits from its least significant bit. The high order part F103a and the low order part F103b are placed in different rows in the Wallace tree array. The first partial product adder F104 adds 0th partial products from the booth selectors B111 to B113 to generate and output a first partial product. The first partial product adder F104 is divided into a high order part F104a including high-order 12 bits and a low order part F104b including low-order 21 bits at the border between the 21st and 22nd bits from its least significant bit. The high order part F104a and the low order part F104b are placed in different rows in the Wallace tree array.

The second partial product adder S101 adds first partial products from the first partial product adders F101 and F102 to generate and output a second partial product. The second partial product adder S101 is divided into a high order part S101 a including high-order 31 bits and a low order part S101b including low-order 8 bits at the border between the 8th and 9th bits from its least significant bit. The high order part S101 a and the low order part S101b are placed in different rows in the Wallace tree array. Particularly, the low order part 5101b is placed in the top row in the Wallace tree array. The second partial product adder S102 adds first partial products from the first partial product adders F103 and F104 to generate and output a second partial product. The second partial product adder S102 is divided into a high order part S102a including high-order 12 bits and a low order part S102b including low-order 25 bits at the border between the 25th and 26th bits from its least significant bit. The high order part S102a and the low order part S102b are placed in different rows in the Wallace tree array.

The third partial product adder T101 adds second partial products from the second partial product adders S101 and S102 to generate and output a third partial product. The third partial product adder T101 is divided into a high order part T101a including high-order 12 bits and a low order part T101b including low-order 33 bits at the border between the 33rd and 34th bits from its least significant bit. The high order part T101a and the low order part T101b are placed in different rows in the Wallace tree array. Particularly, the low order part T101b is placed in a middle row in the Wallace tree array. More specifically, the low order part T101b is placed right under the high order part S101a and right above the low order part S102b. The high order part T101a is placed in the bottom row of the Wallace tree array. More specifically, the high order part T101a is placed right under the high order part S102a.

Thus, in the area where the high order parts B101a to B106a, F101a, F102a, S101a, and the low order part T101b are disposed, the addition is performed from the top to the bottom as shown by the arrow D1. In the area where the low order parts B101b to B106b, F101b, F102b, and S101b are disposed, the addition is performed from the bottom to the top as shown by the arrow D2. In the area where the high order parts B108a to B113a, F103a, F104a, S102a, and T101a are disposed, the addition is performed from the top to the bottom as shown by the arrow D3. In the area where the booth selector B107 and the low order parts B108b to B113b, F103b, F104b, S102b, and T101b are disposed, the addition is performed from the bottom to the top as shown by the arrow D4.

The final adder 3 receives the results of addition from the low order part S101b and the third partial product adder T101. Then the final adder 3 provides the result of the multiplication of the multiplicand by the multiplier. In order to achieve high-speed operation, the final adder 3 employs a high-speed addition method, such as the carry lookahead or carry skip.

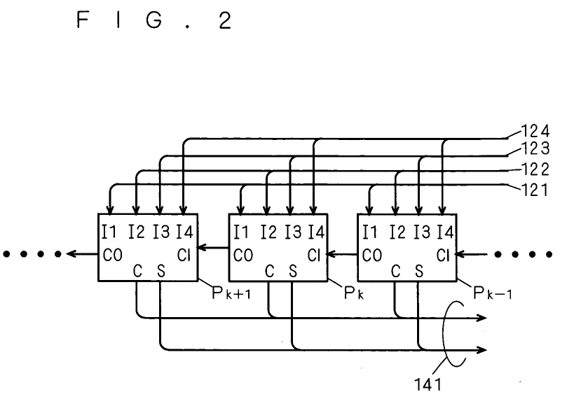

FIG. 2 is a circuit diagram illustrating the configuration of the first partial product adder F102, where only a part corresponding to 3 bits is shown. 4-input (with a carry-in) 2-output (with a carry-out) adder elements Pₖ₊₁, Pₖ, and Pₖ₋₁ are sequentially connected in series. Each of the adder elements Pₖ₊₁, Pₖ, and Pₖ₋₁ corresponds to 1 bit of the first partial product adder F102 shown in FIG. 1. The adder elements Pₖ₊₁, Pₖ, and Pₖ₋₁ each have a carry-in terminal CI, input terminals I1 to I4 each receiving 1 bit of the partial products 121 to 124, a sum terminal S outputting a low order bit of the result of addition of the 5 bits provided to the carry-in terminal CI and the input terminals I1 to I4, and a carry terminal C and a carry-out terminal CO outputting a high order bit of the same order. The carry-out terminals CO of the adder elements Pₖ₊₁, Pₖ, and Pₖ₋₁ are connected respectively to the carry-in terminals CI of the succeeding adder elements. The second partial product adders S101 and S102 and the third partial product adder T101 shown in FIG. 1 are configured the same as the first partial product adder F102 of FIG. 2 except that they have different numbers of input terminals, I1-I4.

As described so far, in the multiplication device of the first preferred embodiment, the maximum-degree partial product adder in the Wallace tree, i.e. the third partial product adder T101, is divided into the high order part T101a and the low order part T101b, and the high order part T101a and the low order part T101b are arranged in different rows in the Wallace tree array. Neither of the number of bits (12 bits) of the high order part T101a and the number of bits (33 bits) of the low order part T101b is more than the number of bits (33 bits) of the booth selectors B101 to B113, so that the high order part T101a and the low order part T101b do not spatially protrude beyond the booth selectors B101 to B113. This avoids formation of dead area in the Wallace tree array that would otherwise be caused by protrusion of the third partial product adder T101.

Referring to FIG. 1, while a space is left on the left of the low order parts S101b and F101b, this space is not a dead area because the booth encoder 2 is provided there, and so area efficiency is not lowered. Similarly, the final adder 3 is provided in the space on the right of the high order parts F104a, S102a, and T101a, so that this space is not a dead area and does not lower the area efficiency.

In the multiplication device of the first preferred embodiment, the critical path of the Wallace tree array is the route from the low order part B113b to the final adder 3 sequentially passing through the low order parts F104b, S102b, T101b, and the high order part T101a. The longest interconnection in this route is the carry path interconnection that connects the carry-out terminal CO of the adder element corresponding to the most significant bit of the low order part T101b and the carry-in terminal CI of the adder element corresponding to the least significant bit of the high order part T101a. Now, in the multiplication device of the first preferred embodiment, the low order part T101b is positioned in a middle row in the Wallace tree array. Accordingly, as compared with a multiplication device in which the low order part T101b is positioned in the top row of the Wallace tree array (e.g. the multiplication device disclosed in the second patent document mentioned earlier), the interconnection length of this carry path is shorter, which suppresses multiplying speed reduction.

In the multiplication device of the first preferred embodiment, since the multiplication result by the low order part S101b is inputted to the final adder 3, the length of the interconnection connecting the low order part S101b and the final adder 3 (referred to as “interconnection W” hereinafter) is longer than the interconnection length of the above-mentioned carry path. However, the multiplication result by the low order part S101b is inputted to the final adder 3 without passing through the third partial product adder T101. Therefore, the result from the low order part S101b is propagated to the final adder 3 through one fewer partial product adder stages than those from the high order parts S101a, S102a and the low order part S102b. Accordingly the length of the interconnection W does not cause reduction of multiplying speed.

### Second Preferred Embodiment

While the first preferred embodiment has shown the layout of a 32-bit-multiplicand×25-bit-multiplier multiplication device, the numbers of bits of the multiplicand and multiplier are not limited to these numbers but can be any numbers of bits. A second preferred embodiment describes an expanded version of the multiplication device of the first preferred embodiment for multiplication of 54-bit multiplicand×54-bit multiplier.

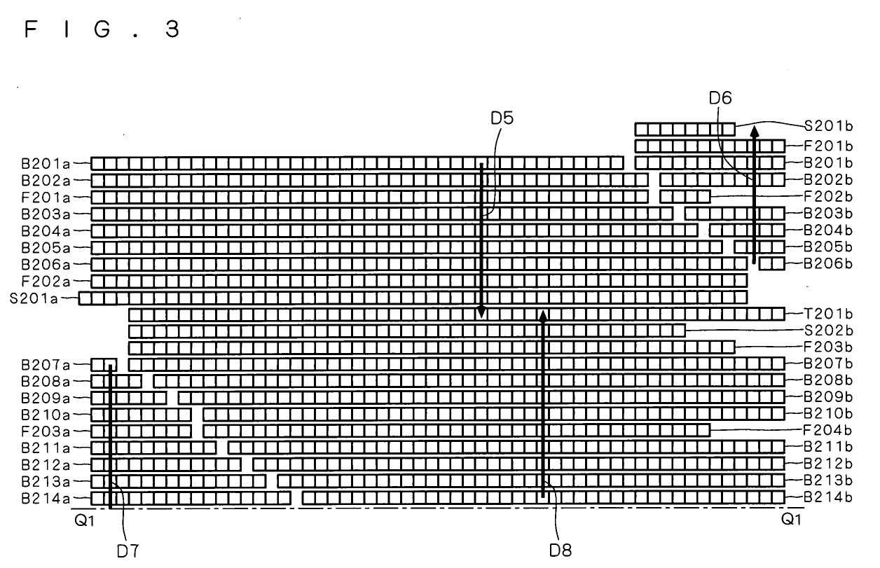

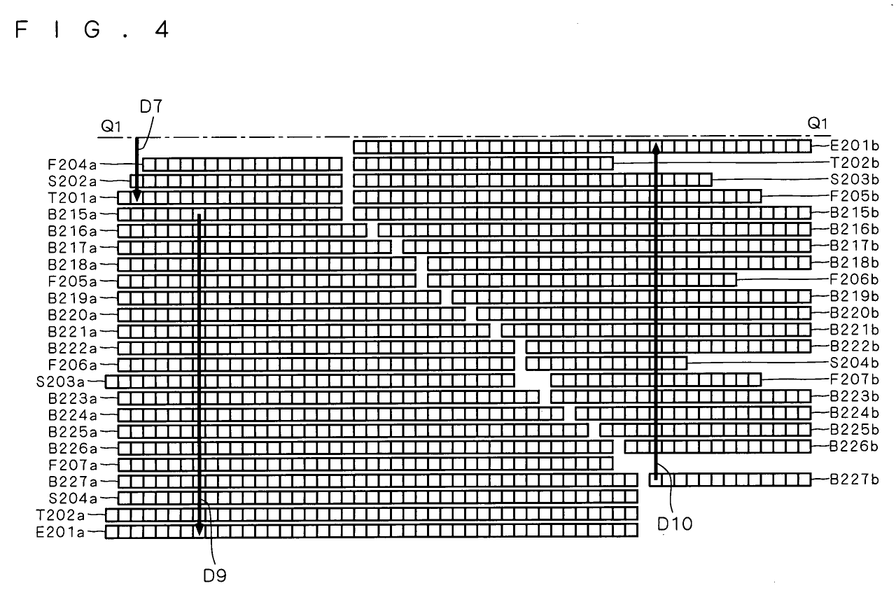

FIGS. 3 and 4 together schematically show a first layout of the multiplication device of the second preferred embodiment of the invention. FIGS. 3 and 4 continue together at line Q1-Q1. Note that FIGS. 3 and 4 do not show the X driver 1, the booth encoder 2, and the final adder 3 shown in FIG. 1.

Booth selectors B201 to B227 are divided into high order parts B201a to B227a, respectively, and low order parts B201b to B227b, respectively. First partial product adders F201 to F207 are divided respectively into high order parts F201a to F207a and low order parts F201b to F207b. Second partial product adders S201 to S204 are divided respectively into high order parts S201a to S204a and low order parts S201b to S204b. Third partial product adders T201 and T202 are divided respectively into high order parts T201a and T202a and low order parts T201b and T202b. A fourth partial product adder E201 is divided into a high order part E201a and a low order part E201b. Particularly, the low order part E201b is placed in a middle row in the Wallace tree array. More specifically, the low order part E201b is placed right above the low order part T202b. The high order part E201a is placed in the bottom row of the Wallace tree array. More specifically, the high order part E201a is positioned right under the high order part T202a.

In the area where the high order parts B201a to B206a, F201a, F202a, S201a and the low order part T201b are provided, the addition is performed from the top to the bottom as shown by the arrow D5. In the area where the low order parts B201b to B206b, F201b, F202b, and S201b are provided, the addition is performed from the bottom to the top as shown by the arrow D6. In the area where the high order parts B207a to B214a, F203a, F204a, S202a, and T201a are provided, the addition is performed from the top to the bottom as shown by the arrow D7. In the area where the low order parts B207b to B214b, F203b, F204b, S202b, and T201b are provided, the addition is performed from the bottom to the top as shown by the arrow D8. In the area where the high order parts B215a to B227a, F205a to F207a, S203a, S204a, T202a, and E201a are provided, the addition is performed from the top to the bottom as shown by the arrow D9. In the area where the low order parts B215b to B227b, F205b to F207b, S203b, S204b, T202b, and E201b are provided, the addition is performed from the bottom to the top as shown by the arrow D10.

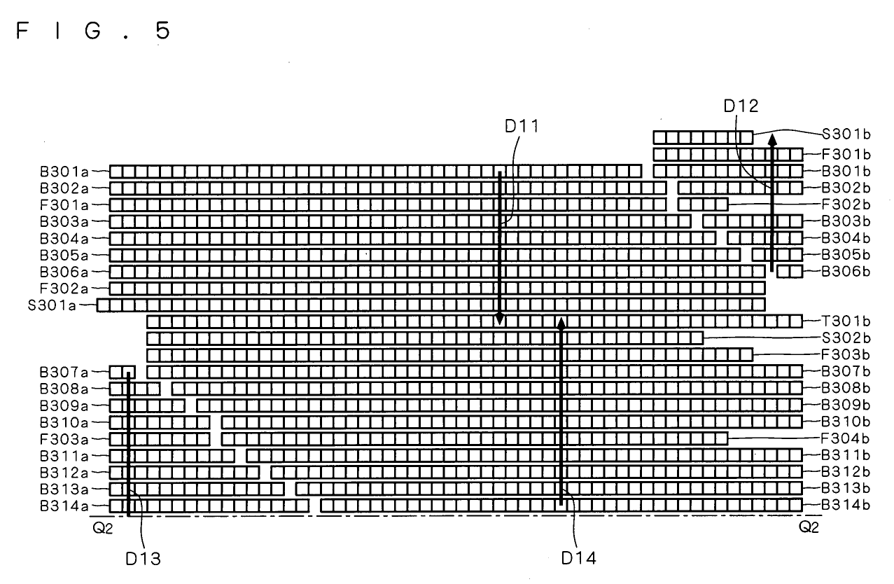

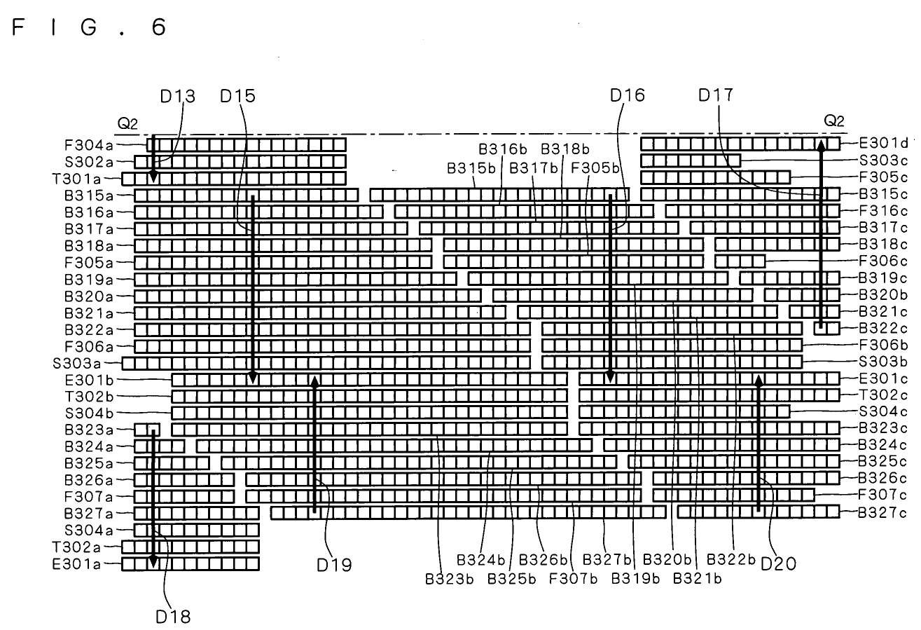

FIGS. 5 and 6 together schematically show a second layout of the multiplication device of the second preferred embodiment of the invention. FIGS. 5 and 6 continue together at line Q2-Q2. Note that FIGS. 5 and 6 do not show the X driver 1, booth encoder 2, and final adder 3 shown in FIG. 1.

Booth selectors B301 to B314 are divided respectively into high order parts B301a to B314a and respectively into low order parts B301b to B314b. Booth selectors B315 to B327 are divided respectively into high order parts B315a to B327a, middle order parts B315b to B327b, and low order parts B315c to B327c. First partial product adders F301 to F304 are divided respectively into high order parts F301a to F304a and low order parts F301b to F304b. First partial product adders F305 to F307 are divided respectively into high order parts F305a to F307a, middle order parts F305b to F307b, and low order parts F305c to F307c. Second partial product adders S301 and S302 are divided respectively into high order parts S301a and S302a and low order parts S301b and S302b. Second partial product adders S303 and S304 are divided respectively into high order parts S303a and S304a, middle order parts S303b and S304b, and low order parts S303c and S304c. A third partial product adder T301 is divided into a high order part T301a and a low order part T301b. A third partial product adder T302 is divided into a high order part T302a, a middle order part T302b, and a low order part T302c. A fourth partial product adder E301 is divided into a high order part E301a, middle order parts E301b and E301c, and a low order part E301d. Particularly, the low order part E301d is placed in a middle row in the Wallace tree array. More specifically, the low order part E301d is placed right above the low order part S303c. The high order part E301a is placed in the bottom row of the Wallace tree array. More specifically, the high order part E301a is positioned right under the high order part T302a.

In the area where the high order parts B301a to B306a, F301a, F302a, S301a and the low order part T301b are provided, the addition is performed from the top to the bottom as shown by the arrow D11. In the area where the low order parts B301b to B306b, F301b, F302b, and S301b are provided, the addition is performed from the bottom to the top as shown by the arrow D12. In the area where the high order parts B307a to B314a, F303a, F304a, S302a, and T301a are provided, the addition is performed from the top to the bottom as shown by the arrow D13. In the area where the low order parts B307b to B314b, F303b, F304b, S302b, and T301b are provided, the addition is performed from the bottom to the top as shown by the arrow D14. In the area where the high order parts B315a to B322a, F305a, F306a, S303a, and the middle order part E301b are provided, the addition is performed from the top to the bottom as shown by the arrow D15. In the area where the middle order parts B315b to B322b, F305b, F306b, S303b, and E301c are provided, the addition is performed from the top to the bottom as shown by the arrow D16. In the area where the low order parts B315c to B322c, F305c, F306c, S303c, and E301d are provided, the addition is performed from the bottom to the top as shown by the arrow D17. In the area where the high order parts B323a to B327a, F307a, S304a, T302a, and E301a are provided, the addition is performed from the top to the bottom as shown by the arrow D18. In the area where the middle parts B323b to B327b, F307b, S304b, T302b, and E301b are provided, the addition is performed from the bottom to the top as shown by the arrow D19. In the area where the low order parts B323c to B327c, F307c, S304c, T302c, and the middle order part E301c are provided, the addition is performed from the bottom to the top as shown by the arrow D20.

In the multiplication device shown in FIGS. 3 and 4, the maximum-degree partial product adder in the Wallace tree, i.e. the fourth partial product adder E201, is divided into the high order part E201a and the low order part E201b, and the high order part E201a and the low order part E201b are arranged in different rows in the Wallace tree array. The number of bits (43 bits) of the high order part E201 a and the number of bits (37 bits) of the low order part E201b are both less than the number of bits (55 bits) of the booth selectors B201 to B227, so that the high order part E201a and the low order part E201b do not spatially protrude beyond the booth selectors B201 to B227. Similarly, in the multiplication device shown in FIGS. 5 and 6, the maximum-degree partial product adder in the Wallace tree, i.e. the fourth partial product adder E301, is divided into the high order part E301a, the middle order parts E301b and E301c, and the low order part E301d, where the high order part E301a, the middle order parts E301b and E301c, and the low order part E301d are arranged in different rows in the Wallace tree array. The number of bits (11 bits) of the high order part E301a, the number of bits (53 bits) of the middle order parts E301b and E301c, and the number of bits (16 bits) of the low order part E301d are all less than the number of bits (55 bits) of the booth selectors B301 to B327, so that the high order part E301a, the middle order parts E301b and E301c, and the low order part E301d do not spatially protrude beyond the booth selectors B301 to B327. Thus, the multiplication device of the second preferred embodiment avoids formation of dead area in the Wallace tree array that would otherwise be caused by protrusion of the fourth partial product adders E201 and E301.

In the multiplication device shown in FIGS. 3 and 4, the critical path of the Wallace tree array is the route passing from the low order part B226b to the final adder 3 sequentially through the low order parts F207b, S204b, T202b, E201b and the high order part E201a. The longest interconnection in this route is the carry path interconnection that connects the carry-out terminal CO of the adder element corresponding to the most significant bit of the low order part E201b and the carry-in terminal CI of the adder element corresponding to the least significant bit of the high order part E201a. Now, in the multiplication device of the second preferred embodiment, the low order part E201b is positioned in a middle row in the Wallace tree array. Accordingly, as compared with a multiplication device in which the low order part E201b is positioned in the top row of the Wallace tree array, the interconnection length of this carry path is shorter, which suppresses multiplying speed reduction. The same is true with the multiplication device shown in FIGS. 5 and 6.

### Third Preferred Embodiment

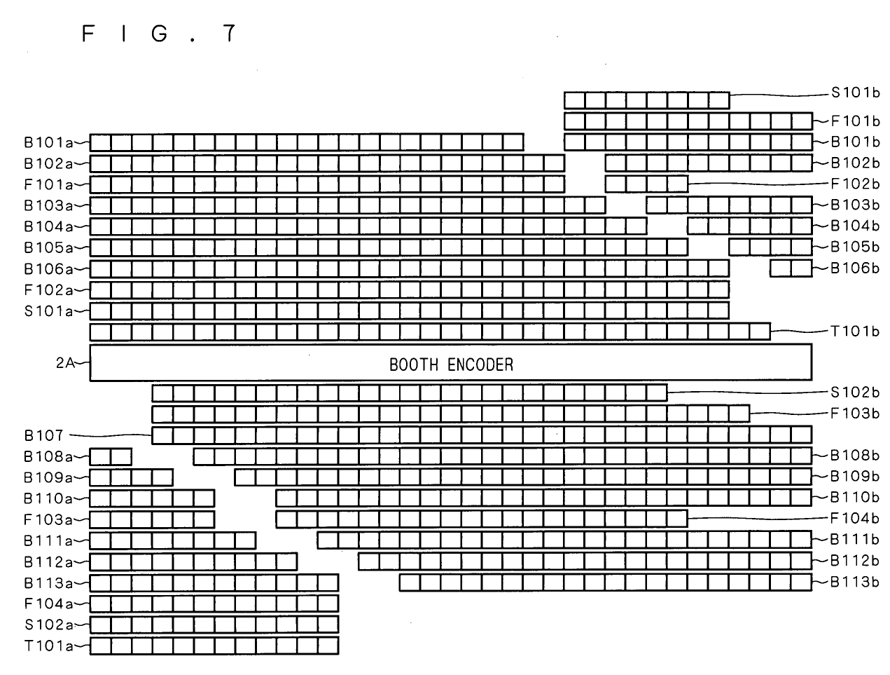

FIG. 7 is a diagram schematically showing the layout of a multiplication device according to a third preferred embodiment of the invention. FIG. 7 does not show the X driver 1 and the final adder 3 shown in FIG. 1. While the multiplication device of the first preferred embodiment has the booth encoder 2 placed in the left part of the top side of the Wallace tree array, the multiplication device of the third preferred embodiment includes a booth encoder 2A, in place of the booth encoder 2, that is placed in a middle row in the Wallace tree array. More specifically, the booth encoder 2A is placed between the low order part T101b and the low order part S102b. Like the booth encoder 2, the booth encoder 2A reduces a 25-bit multiplier to a 13-bit modified multiplier (booth1 to booth13) according to the Booth's algorithm and outputs them respectively to the booth selectors B101 to B113.

The booth encoder 2A has a first driver (not shown) for the booth selectors B101 to B106 and a second driver (not shown) for the booth selectors B107 to B113. The first driver and the second driver are paralleled to each other.

Except that the booth encoder 2 is replaced by the booth encoder 2A, the configuration and operation of the multiplication device of the third preferred embodiment are the same as those of the multiplication device of the first preferred embodiment, and so they are not described in detail here again. However, note that the invention of the third preferred embodiment is applicable also to the multiplication device of the second preferred embodiment.

The multiplication device of the third preferred embodiment is capable of simultaneously performing the output operation of the modified multipliers booth1 to booth6 from the first driver to the booth selectors B101 to B106 and the output operation of the modified multipliers booth7 to booth13 from the second driver to the booth selectors B107 to B113. Furthermore, the interconnection length between the booth encoder 2A and the booth selectors (the booth selectors B101 and B113) that are farthest from the booth encoder 2A is reduced to about ½ of the interconnection length between the booth encoder 2 shown in FIG. 1 and the booth selector (the booth selector B113) farthest from the booth encoder 2. Accordingly, the multiplication device of the third preferred embodiment offers higher signal propagation speed from the booth encoder 2A to the booth selectors B101 to B113, as compared with the multiplication device of the first preferred embodiment.

### Fourth Preferred Embodiment

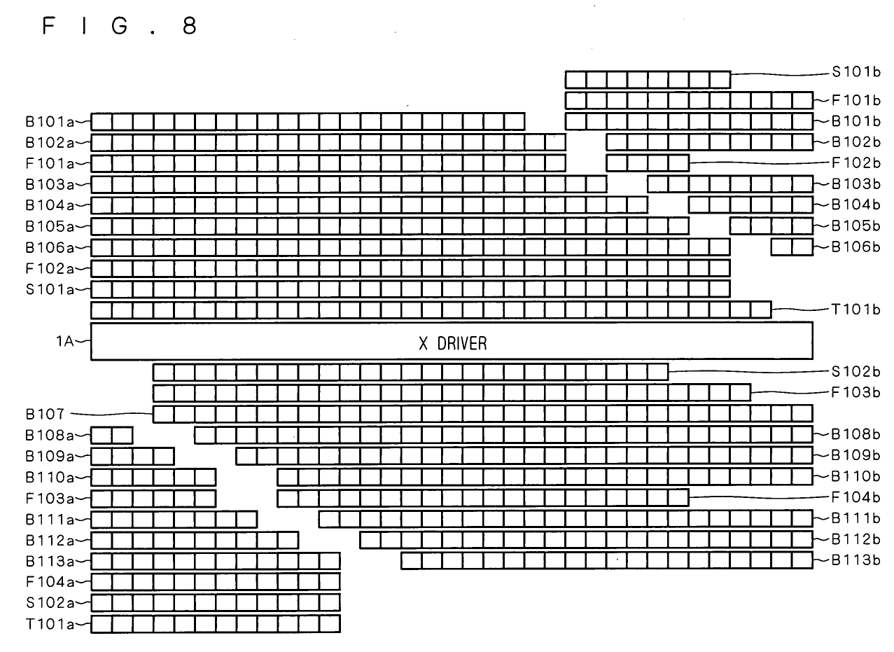

FIG. 8 is a diagram schematically showing the layout of a multiplication device according to a fourth preferred embodiment of the invention. FIG. 8 does not show the booth encoder 2 and the final adder 3 shown in FIG. 1. While the multiplication device of the first preferred embodiment has the X driver 1 provided at the top side of the Wallace tree array, the multiplication device of the fourth preferred embodiment includes an X driver 1A, in place of the X driver 1, that is placed in a middle row in the Wallace tree array. More specifically, the X driver 1A is placed between the low order part T101b and the low order part S102b. Like the X driver 1, the X driver 1A functions as a driving buffer for driving the multiplicand, which gives the multiplicand to the booth selectors B101 to B113.

The X driver 1 A has a first driver (not shown) for the booth selectors B101 to B106 and a second driver (not shown) for the booth selectors B107 to B113. The first driver and the second driver are paralleled to each other.

Except that the X driver 1 is replaced by the X driver 1A, the configuration and operation of the multiplication device of the fourth preferred embodiment are the same as those of the multiplication device of the first preferred embodiment, and so they are not described in detail here again. However, note that the invention of the fourth preferred embodiment is applicable also to the multiplication devices of the second and third preferred embodiments.

Thus, the multiplication device of the fourth preferred embodiment is capable of simultaneously performing the output operation of the multiplicand from the first driver to the booth selectors B101 to B106 and the output operation of the multiplicand from the second driver to the booth selectors B107 to B113. Furthermore, the interconnection length between the X driver 1A and the booth selectors (the booth selectors B101 and B113) that are farthest from the X driver 1A is reduced to about ½ of the interconnection length between the X driver 1 shown in FIG. 1 and the booth selector (the booth selector B113) that is farthest from the X driver 1. Accordingly, the multiplication device of the fourth preferred embodiment offers higher signal propagation speed from the X driver 1A to the booth selectors B101 to B113, as compared with the multiplication device of the first preferred embodiment.

### Fifth Preferred Embodiment

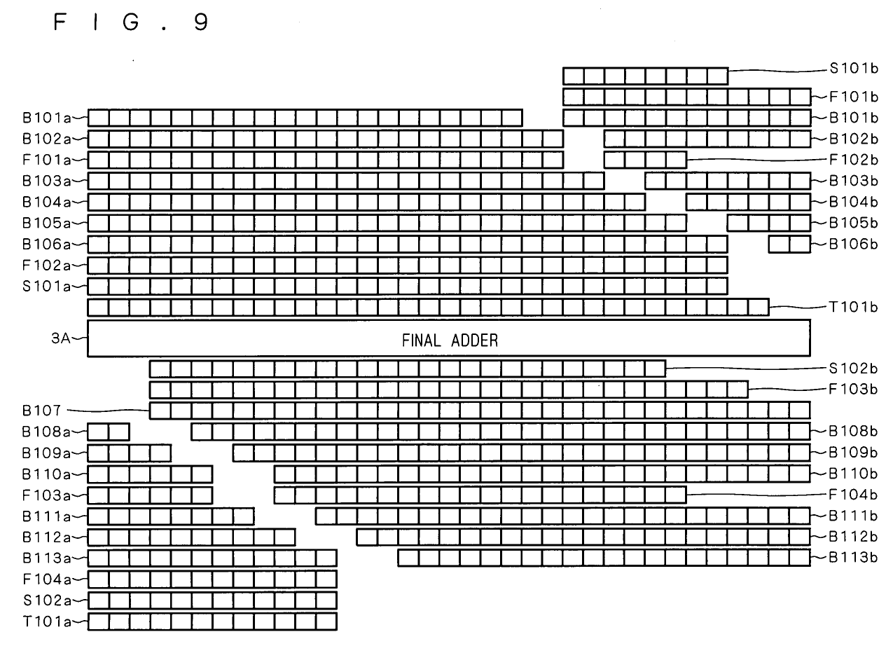

FIG. 9 is a diagram schematically showing the layout of a multiplication device according to a fifth preferred embodiment of the invention. FIG. 9 does not show the X driver 1 and the booth encoder 2 shown in FIG. 1. While the multiplication device of the first preferred embodiment has the final adder 3 provided in the right part of the bottom side of the Wallace tree array, the multiplication device of the fifth preferred embodiment has a final adder 3A, in place of the final adder 3, that is provided in a middle row in the Wallace tree array. More specifically, the final adder 3A is placed right under the low order part T101b. Like the final adder 3, the final adder 3A receives results of addition from the low order part S101b and the third partial product adder T101 and obtains the result of multiplication of the multiplicand by the multiplier.

Except that the final adder 3 is replaced by the final adder 3A, the configuration and operation of the multiplication device of the fifth preferred embodiment are the same as those of the multiplication device of the first preferred embodiment, and so they are not described in detail here again. However, note that the invention of the fifth preferred embodiment is applicable also to the multiplication devices of the second to fourth preferred embodiments.

According to the multiplication device of the fifth preferred embodiment, the interconnection length between the final adder 3A and the low order part T101b is reduced than the interconnection length between the final adder 3 shown in FIG. 1 and the low order part T101b. Accordingly, the multiplication device of the fifth preferred embodiment offers higher signal propagation speed from the low order part T101b to the final adder 3A, as compared with the multiplication device of the first preferred embodiment.

### Sixth Preferred Embodiment

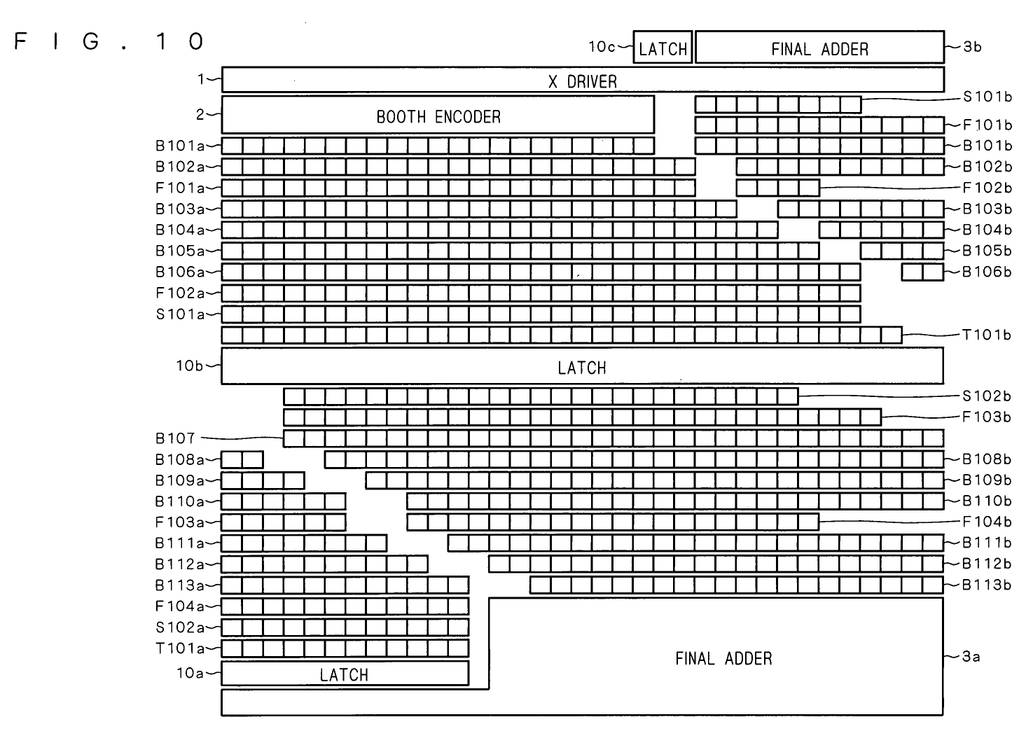

FIG. 10 is a diagram schematically showing the layout of a multiplication device according to a sixth preferred embodiment of the invention. While the multiplication device of the first preferred embodiment has the final adder 3 placed in the right part of the bottom side of the Wallace tree array, the multiplication device of the sixth preferred embodiment has a high-order final adder 3a and a low-order final adder 3b in place of the final adder 3, where the high-order final adder 3a and the low-order final adder 3b are divided at the border between the 12th and 13th bits from the least significant bit of the multiplicand. The final adder 3a is placed at the bottom side of the Wallace tree array and the final adder 3b is placed near the low order part S101b, in the right part at the top side of the Wallace tree array. The final adders 3a and 3b are thus arranged so that the Wallace tree array is interposed between them. The final adder 3a receives a third partial product from the third partial product adder T101 and the final adder 3b receives a second partial product from the low order part S101b. Then, like the final adder 3 shown in FIG. 1, the final adders 3a and 3b obtain the result of the multiplication of the multiplicand by the multiplier.

The multiplication device of the sixth preferred embodiment further includes a latch 10a interposed between the high order part T101a and the final adder 3a, a latch 10b interposed between the low order part T101b and the final adder 3a, and a latch 10c interposed between the final adder 3b and the final adder 3a. Third partial products outputted from the high order part T101a and the low order part T101b are inputted to the final adder 3a respectively through the latches 10a and 10b. A carry signal outputted from the final adder 3b is inputted to the final adder 3a through the latch 10c. That is to say, the insertion of the latches 10a to 10c provides the multiplication device with a pipeline configuration.

Except for these modifications, the configuration and operation of the multiplication device of the sixth preferred embodiment are the same as those of the multiplication device of the first preferred embodiment, and so they are not described in detail here again. However, note that the invention of the sixth preferred embodiment is applicable also to the multiplication devices of the second to fourth preferred embodiments.

Thus, according to the multiplication device of the sixth preferred embodiment, the final adder 3b is placed proximate to the low order part S101b, which shortens the interconnection length between the low order part S101b and the final adder 3b, thus speeding up addition in the final adder 3b.

When two final adders 3a and 3b are arranged so that the Wallace tree array is interposed between them, the carry path from the low-order final adder 3b to the high-order final adder 3a extends over the Wallace tree array, and so the long interconnection length lowers speed. However, the multiplication device of the sixth preferred embodiment is provided with a pipeline configuration by the provision of the latches 10a to 10c, where the carry signal outputted from the final adder 3b is once held in the latch 10c and then inputted to the final adder 3a. This avoids the speed reduction problem.

Modifications.

In the multiplication devices of the first, second, and fourth to sixth preferred embodiments, the booth encoder 2 may be placed at any of the four sides of the Wallace tree array, depending on design requirements. Also, the both encoder 2 may be omitted, in which case the multiplier is inputted to the shifter/inverters without being modified.

In the multiplication devices of the first to third, fifth, and sixth preferred embodiments, the X driver 1 may be placed at any of the four sides of the Wallace tree array depending on design requirements.

In the multiplication devices of the first to fourth preferred embodiments, the final adder 3 may be placed at any of the four sides of the Wallace tree array depending on design requirements.

While the invention has been described in detail, the foregoing description is in all aspects illustrative and not restrictive. It is understood that numerous other modifications and variations can be devised without departing from the scope of the invention.

1. An arithmetic unit comprising:
a partial product generating portion that receives a multiplicand and a multiplier and generates 0th partial products;
an array-form Wallace tree portion having jth partial product adders that add ith (0≦i≦m-1) partial products to generate jth (j=i+1) partial products, so as to perform an addition in a tree-like manner while sequentially reducing the number of partial products to finally output an mth partial product from an mth partial product adder; and
a final adder that receives said mth partial product and obtains a result of a multiplication of said multiplicand by said multiplier,
wherein each said jth partial product adder is divided into a plurality of parts at a border between particular positions of said multiplicand and said plurality of parts are placed in different rows in said array, and
said mth partial product adder has a first part provided in a row at an end of said array and a second part provided in a middle row in said array.

2. The arithmetic unit according to claim 1, further comprising a booth encoder that modifies said multiplier according to a Booth's algorithm, wherein said booth encoder is provided in a middle row in said array.

3. The arithmetic unit according to claim 1, further comprising a driving buffer that gives said multiplicand to said partial product generating portion, wherein said driving buffer is provided in a middle row in said array.

4. The arithmetic unit according to claim 1, wherein said final adder is provided in a middle row in said array.

5. The arithmetic unit according to claim 1, wherein said final adder is divided into a low order part and a high order part at a border between particular positions of said multiplicand and said low and high order parts are arranged so that said array is interposed therebetween.

6. The arithmetic unit according to claim 5, further comprising a latch connected to said mth partial product adder and said final adder, wherein a pipeline configuration is formed by inputting said mth partial product to said final adder through said latch and by inputting a carry outputted from said low order part to said high order part through said latch.
